(19) United States
(12) Patent Application Publication
(10) Pub. No.: US 2016/0005000 A1
(43) Pub. Date: Jan. 7, 2016

(54) Systems and Methods for Managing Career Development Experiences Within a Company

(71) Applicant: MASTERCARD INTERNATIONAL INCORPORATED, Purchase, NY (US)

(72) Inventors: Susan Ross, Rye, NY (US); Barbara Davis, White Plains, NY (US)

(21) Appl. No.: 14/322,865

(22) Filed: Jul. 2, 2014

(51) Int. Cl. G06Q 10/10

(52) U.S. Cl. CPC G06Q 10/1053

(57) ABSTRACT

Systems and methods are provided for managing career development experiences within a company. One exemplary system includes a memory configured to store, in an offer database, development experience information for multiple career development experiences, and a processor coupled to the memory. The processor is configured to generate a development experience, in response to an experience creation request from a first employee of the company directed to a second employee of the company. The development experience includes at least one task outside a plurality of job duties of the second employee. The processor is also configured to post the development experience to the offer database, and notify the first employee of an experience acceptance reply from the second employee when the second employee indicates interest in participating in the posted development experience.

### FIELD

The present disclosure generally relates to systems and methods for managing career development experiences within a company.

### BACKGROUND

This section provides background information related to the present disclosure which is not necessarily prior art.

Employees of companies occasionally attempt to develop their careers within the companies by learning new skills, gaining new experiences, collaborating with other employees, etc. Similarly, managers often attempt to improve performance of their work groups, including any employees they supervise, by providing coaching/mentoring and/or by encouraging employees to take advantage of resources the company makes available, such as educational assistance, formal/informal training opportunities, etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in managing career development experiences within a company.

FIG. 2 is a block diagram of a computing device that may be used in the exemplary system of FIG. 1.

FIG. 3 is an exemplary method for use in managing career development experiences within a company.

FIG. 4 is an exemplary interface suitable for use in the system of FIG. 1 and/or the method of FIG. 3, as may be displayed at the computing device of FIG. 2, illustrating a creator dashboard.

FIG. 5 is an exemplary interface suitable for use in the system of FIG. 1 and/or the method of FIG. 3, as may be displayed at the computing device of FIG. 2, for creating an experience request.

FIG. 6 is an exemplary interface suitable for use in the system of FIG. 1 and/or the method of FIG. 3, as may be displayed on the computing device of FIG. 2, displaying multiple development experiences.

FIG. 7 is an exemplary interface suitable for use in the system of FIG. 1 and/or the method of FIG. 3, as may be displayed on the computing device of FIG. 2, for displaying details of a particular development experience.

FIG. 8 is an exemplary interface suitable for use in the system of FIG. 1 and/or the method of FIG. 3, as may be displayed on the computing device of FIG. 2, for receiving an experience acceptance reply from a seeker interested in participating in a development experience.

FIG. 9 is an exemplary interface suitable for use in the system of FIG. 1 and/or the method of FIG. 3, as may be displayed on the computing device of FIG. 2, illustrating a seeker dashboard.

FIG. 10 is an exemplary interface suitable for use in the system of FIG. 1 and/or the method of FIG. 3, as may be displayed on the computing device of FIG. 2, for receiving feedback from a seeker after completion of a development experience.

FIG. 11 is an exemplary interface suitable for use in the system of FIG. 1 and/or the method of FIG. 3, as may be displayed on the computing device of FIG. 2, for receiving feedback from a creator after completion of a development experience.

Corresponding reference numerals indicate corresponding parts throughout the several views of the drawings.

### DETAILED DESCRIPTION

Example embodiments will now be described more fully with reference to the accompanying drawings.

According to some exemplary aspects of the present disclosure, systems and methods for managing career development experiences within a company, within a network of companies, etc. are provided. Some employees of the company, of the companies within the network, may desire to participate in development experiences to further grow their careers within the company. Similarly, some employees may desire to accomplish certain tasks, and may offer such tasks to other employees of the company, other employees of the companies in the network, etc. in an effort to permit them to further their careers. The exemplary systems and methods facilitate career development experiences between employees by allowing a development experience to be offered by a first employee (referred to herein as a creator), and to be accepted by a second employee (referred to herein as a seeker). The exemplary systems and methods allow the employees to more efficiently create and select (and share) development experiences, and to participate in career development, which may occur across business units, at different locations (including different international locations), etc.

The companies have multiple employees employed in different employment positions, with each employment position having a plurality of duties. For example, a first employee may be employed in a software employment position having duties of writing software code and testing software code; a second employee may be employed in an accountant employment position having duties of recording transactions and periodically generating financial reports; a third employee may be employed in a project management employment role having duties of supervising a group of employees and monitoring status of a project; etc.

A development experience may be any opportunity for an employee to perform at least one task outside the duties associated with the position of the employee (however, it may not be a guarantee for a job change or promotion). For example, a software engineer may wish to learn about financial reports; an accountant may want to learn about monitoring project status; a project manager may want to learn about software testing, etc. As such, the development experience is not a new job or a different position or promotion, but is instead a discrete task different from, and in addition to, the employee's normal job duties. The discrete task, as offered by the creator, is expected to permit the seeker employee to develop further skills or other knowledge (outside of his/her normal job duties) to further his/her career, or identify a potential different career path. Each development experience generally lasts for a time period such as, for example, approximately one work day or slightly more or less (e.g., less than ten hours, less than eight hours, less than two hours, etc.) and may occur all within the same day, or may be split up over multiple days (which may occur during the same or different weeks, months, etc.). In some aspects, the development experiences may be limited to employees in good standing with the companies, and/or may be limited to employees with a minimum period of employment with the companies (e.g., at least six months, etc.), etc. In addition, in some aspects the employees may not need manager approval to participate in a development experience, but may be required to inform their manager of such participation (or interest in such participation). Further, in some aspects, the development experiences may connect employees through in-person experiences, or the experiences may be virtual, etc.

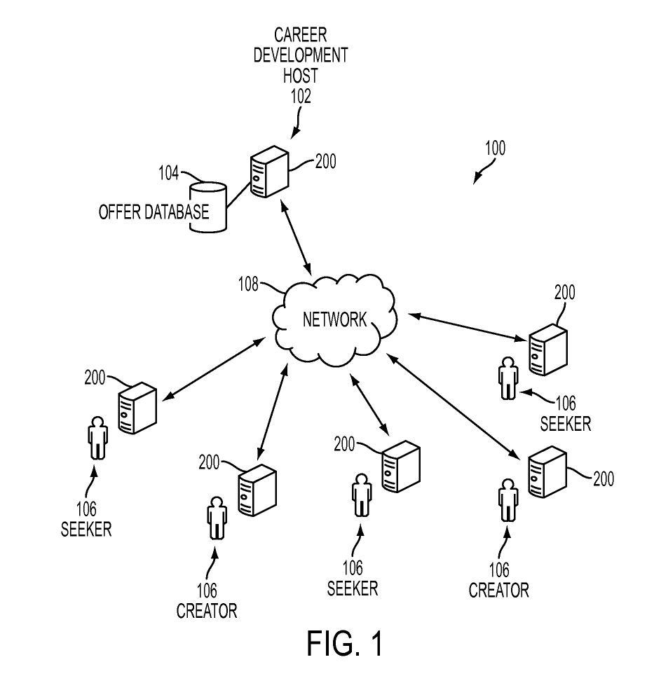

FIG. 1 illustrates an exemplary system 100, in which the one or more aspects of the present disclosure may be implemented. As will be described, the system 100 can facilitate managing career development experiences within a company. Although, in the described embodiment, components of the system 100 are presented in one arrangement, other embodiments may include the same or different components arranged otherwise, depending, for example, on the arrangement of a company's computer network, etc. For example, in some embodiments the exemplary system 100 can facilitate managing career development experiences between employees in networks of companies (not just within a single company).

Referring to FIG. 1, the system 100 includes a career development host 102 coupled to an offer database 104, which may be integrated with or separate from the career development host 102. The offer database 104 may be configured to store development experience information for one or more development experiences available, through the company, in the system 100. Development experience information may include any information related to details of a development experience, including, without limitation, a subject of the development experience, a title of the development experience, a location of the experience, a time commitment required to participate in the experience, a length of time to complete the experience, potential skills to be developed through the experience, a description of the experience, a date the experience starts, a date the experience ends, a number of participants allowed in the development experience, a date of availability, a date of experience expiration, etc.

Employees of the company (i.e., creators and seekers) (generally indicated at 106 in FIG. 1) can access the system 100 using computing devices 200 (described more below). For example, a creator can use a computing device 200 to create development experiences to be posted to the offer database 104. The creator can enter details about the offered development experiences (through various interfaces, etc. displayed at the computing device 200), which can then be processed by the career development host 102 and stored in the offer database 104. Separately, a seeker can use a computing device 200 to search for desired development experiences in the offer database 104, and apply (e.g., by sending an acceptance reply, etc.) if the seeker finds a development experience they would like to participate in (again through various interfaces, etc. displayed at the computing device 200). In some aspects, the computing devices 200 allow the employees (both the creators and the seekers) to access the system 100 through an employee portal of the company. Employee information/data may then be automatically recognized upon accessing the system 100 (e.g., upon logging in, etc.), for example, based on stored employee profiles on the company intranet, etc. In turn, this may allow various fields of interfaces used in the system 100 to be automatically populated for the employees (e.g., name, job title, location, profile, etc.) for convenience.

As shown in the system 100, each of the employees 106 is associated with a computing device 200. In addition, the career development host 102 is implemented as one or more computing devices 200, which may be located together or distributed across a geographic region. The computing devices 200 of the career development host 102 and associated with the employees 106 are coupled to a network 108. The network 108 may include, without limitation, a local area network (LAN), a wide area network (WAN) (e.g., the Internet, etc.), a mobile network, and/or another suitable public and/or private network capable of supporting communication among two or more of the components illustrated in FIG. 1, or any combination thereof. In one example, network 108 is an internal network of the company, i.e., the company intranet, etc.

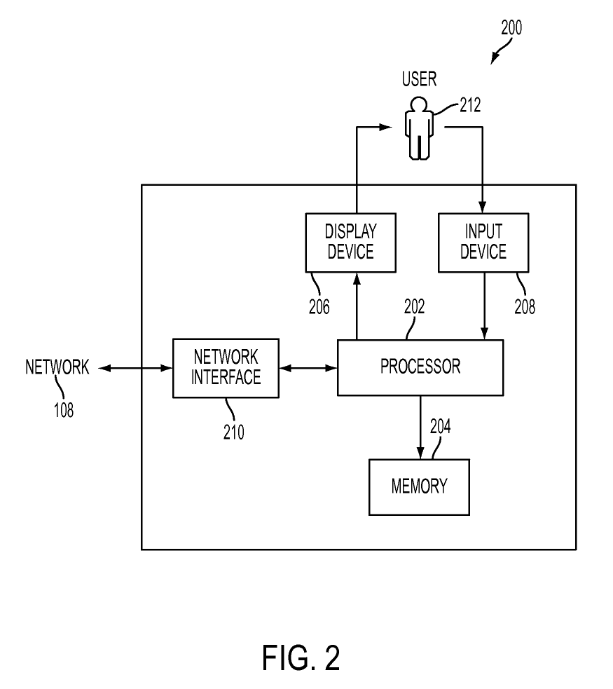

For illustration, the system 100 is described with reference to the exemplary computing device 200 illustrated in FIG. 2. The system 100 and the components therein, however, should not be considered to be limited to the computing device 200, as different computing devices and/or arrangements of computing devices may be used in other embodiments.

The computing device 200 may include, for example, one or more servers, workstations, personal computers, laptops, tablets, PDAs, card reader devices, smartphones, etc.

As shown in FIG. 2, the exemplary computing device 200 includes a processor 202 and a memory 204 that is coupled to the processor 202. The processor 202 may include one or more processing units (e.g., in a multi-core configuration, etc.). The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The memory 204, as described herein, is one or more devices that enable information, such as computer-executable instructions and/or other data, to be stored and retrieved. The memory 204 may include one or more computer-readable media, such as, without limitation, dynamic random access memory (DRAM), static random access memory (SRAM), read only memory (ROM), solid state devices, and/or hard disks. The memory 204 may be configured to store, without limitation, development experience information, employee information, company information, etc.

In the exemplary embodiment, computing device 200 includes a display device 206 that is coupled to the processor 202. Display device 206 outputs to a user 212 (e.g., an employee, etc.) by, for example, displaying and/or otherwise outputting information such as, but not limited to, pages, applications, development experience information, employee information, company information, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphic user interfaces (GUI), or webpages, etc.) may be displayed at computing device 200, and in particular at display device 206, to allow employees to generate development experiences, search for development experiences, submit responses regarding development experiences, etc.

The computing device 200 also includes an input device 208 that receives input from the user 212. The input device 208 is coupled to the processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet, a smartphone, or similar device, behaves as both display device 206 and input device 208.

In addition, the illustrated computing device 200 further includes a network interface 210 coupled to the processor 202. The network interface 210 may include, without limitation, a wired network adapter, a wireless network adapter, a mobile telecommunications adapter, or other device capable of communicating to one or more different networks, including network 108. In some exemplary embodiments, the computing device 200 includes the processor 202 and one or more network interfaces incorporated into or with the processor 202.

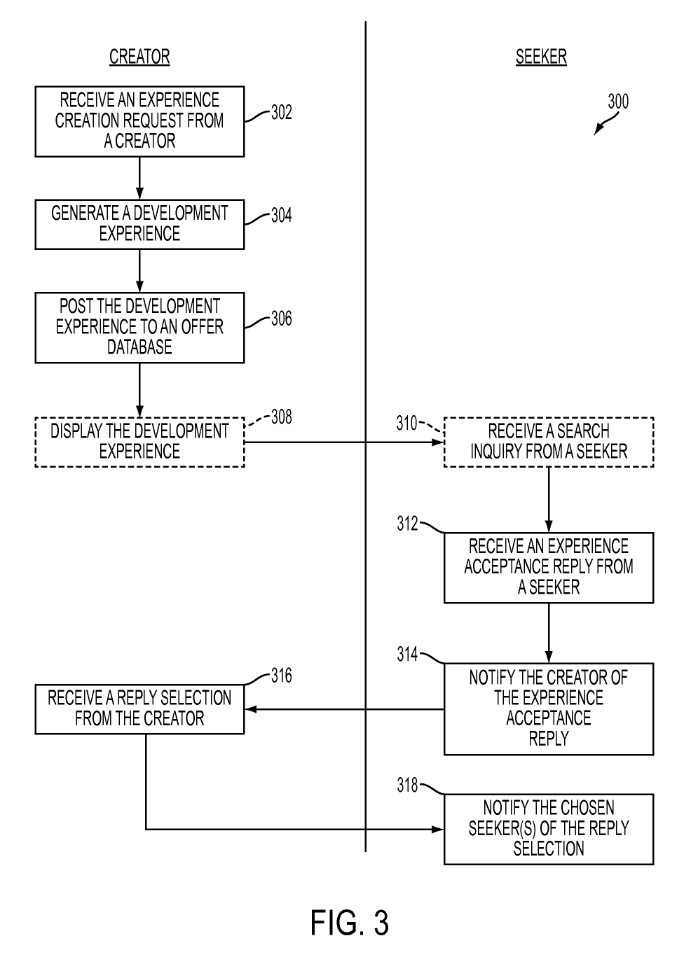

FIG. 3 illustrates an exemplary method 300 of managing career development experiences within a company. The exemplary method 300 is described as implemented in the career development host 102 of the system 100, and in particular, the career development host computing device 200. However, it should be appreciated that the methods described herein are not limited to the system 100, or computing device 200. And, conversely, the systems and computing devices described herein are not limited to the exemplary method 300. As described above, in some embodiments the exemplary method 300 can facilitate managing career development experiences between employees in networks of companies (not just within a single company).

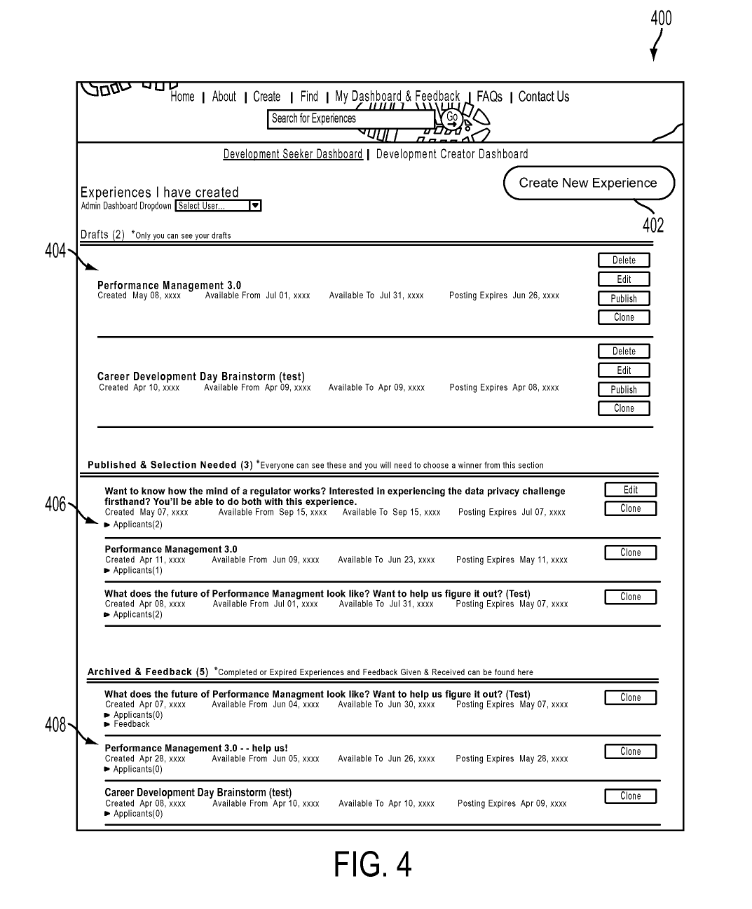

Further, the methods and systems herein are described with reference to the exemplary interfaces illustrated in FIGS. 4-11. The exemplary interfaces may be portions of webpages which are transmitted from the career development host 102 (in one or more forms including packetized data, etc.), through network 108 via one or more of the computing devices 200, and displayed to employees 106 at display devices 206 of the corresponding computing devices 200. Additionally, the interfaces displayed to the employees 106 may solicit information from the employees, which may be entered via corresponding input devices 208 and transmitted to (and thus received by) the career development host 102 via the network 108. In at least one embodiment, the interfaces are portions of webpages from the company intranet site, for example, accessible to the employees of the company. It should be appreciated that the interfaces illustrated in FIGS. 4-11 are merely exemplary, and that a variety of other interfaces, having other forms, other fields, and requesting other information, etc. may be provided.

With reference now to FIG. 3, the exemplary method 300 is directed to the company having multiple employees, including at least one employee creator (i.e., an employee creating (e.g., posting, etc.) a new career development experience offer), and at least one employee seeker (i.e., an employee seeking an offered (and available) career development experience to participate in). FIG. 3 illustrates portions of the method 300 as being directed to either the creator or the seeker, although it should be understood that a single employee is capable of acting as both a creator and a seeker (i.e., an employee may create new development experience offers, and also look to participate in development experiences offered by others).

At 302, the career development host 102 (particularly, the computing device 200) receives an experience creation request (or offer) from an employee creator. The request is submitted by the employee creator, who may wish to offer one or more discrete tasks on a project for which he/she is responsible, or under his/her supervision to another employee. Further, the creator may offer the development opportunity, not solely or necessarily to complete the task, but as a mentoring activity within the company. Examples of development experiences include, without limitation, working with the company's issuing banks in a foreign country division (e.g., a day in the life, etc.), job shadowing company executives, innovating and brainstorming with teams in particular business areas (e.g., to come up with new ideas to meet the needs of customers, etc.), going behind the scenes to learn how company networks operate, attending customer meetings with account representatives, brainstorming on projects to move business forward, etc. As noted above, the employee submitting the offer for the development experience is considered the creator. And, the creator may use the computing device 200 to submit the request to the career development host 102 to create the new development experience offer.

In some aspects, as part of receiving the experience creation request at 302, the development host 102 may initially receive data regarding the request via email, via one or more interfaces presented to the creator (e.g., through the computing devices 200, etc.), etc. Then, after receiving the initial data, the development host 102 may generate the request based on the received data.

In either case, in response to receiving the development experience creation request at 302 (or after generating the request based on the received data), the career development host 102 generates (via the computing device 200) a new development experience at 304. The generated development experience is based on the development experience creation request from the creator. The generated development experience may include any detail about the experience provided by the creator, such as, for example, a subject of the development experience, a title of the development experience, a location of the experience, a time commitment required to participate in the experience, a length of time to complete the experience, potential skills to be developed through the experience, a description of the experience, a maximum and/or minimum number of participants allowed in the development experience, a date of availability, a start and end date of the experience, a date of experience expiration, etc.

The generated development experience is then posted (via the computing device 200) to the offer database 104, at 306. The offer database 104 stores the development experience, along with any information related thereto. In addition, the offer database 104 may store information related to all currently active offered development experiences.

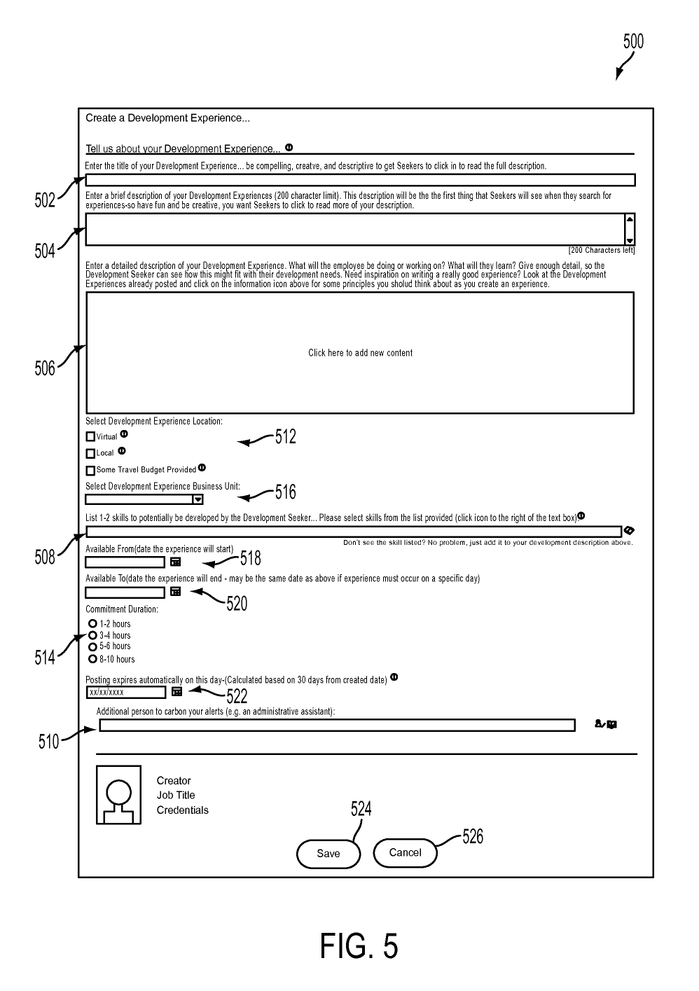

FIGS. 4 and 5 illustrate exemplary interfaces 400, 500 that may be displayed to the employee creator, via the display device 206 of the computing device 200, when creating the development experience (to facilitate receipt of necessary data from the creator to create the experience). Again, the interfaces 400, 500 may be any graphical user interface (GUI) suitable for receiving information from an employee, such as, for example, an Internet webpage, a company employee portal, etc.

The interface 400 in FIG. 4 displays a creator dashboard, illustrating various options and other information available to the creator. The creator can use the dashboard to create a new development experience (via button 402—which then transfers the creator to the interface 500 of FIG. 5), and/or to view existing experiences previously created. The existing experiences displayed to the creator in the interface 400 include all experiences previously created, grouped by status, including draft experiences 402, published experiences 404 (experiences waiting for selection), and completed/archived experiences 406. Each of the displayed existing experiences also includes a brief description (e.g., title, important dates, etc.), options for each experience (e.g., selection buttons to delete, edit, publish, clone, etc. the experience), a status (e.g., draft, published, archived, etc.), and an indication of whether or not action is required (e.g., an indication that a seeker selection needs to be made, that feedback may be provided, etc.). In connection with the existing experiences, the creator can also use the dashboard to delete, edit, publish, or clone the draft experiences 404; to make employee selections for the published experiences 406; and to clone, review, and give feedback on the completed experiences 408. In addition, the dashboard can be personalized for the employee creator, as desired, to provide convenience when creating and organizing development experiences.

When the employee creator selects to create a new development experience at the dashboard in FIG. 4 (via button 402), the interface 500 in FIG. 5 is then displayed for use in collecting particular information from the creator regarding the experience. The illustrated interface 500 includes text-editable fields 502-510 for entering a title (502) of the development experience, a brief description (504) of the development experience (which may be limited in characters), a detailed description (506) of the experience, required skills (508), and a contact person (510) to include on any alerts relating to the experience. Radio button selections 512, 514 are provided to select a location of the development experience and a duration of the experience. And, additional selection options 516-522 are then provided to specify a particular business unit involved in the experience, as well as specific dates of availability for the experience. Once all desired information is provided by the creator, the new development experience can be saved to the creator's dashboard via button 524 where it can then be posted, when desired. Or, the experience can be cancelled via button 526.

With continued reference to FIG. 3, the development experience may optionally (as indicated by the broken lines) be displayed at 308. In particular, the development experience may be displayed on a display device 206 of a computing device 200, which can be viewed by any of the creators and seekers. For example, the development experience may be displayed on a company website, employee portal, human resources career management center, etc. The development experience may be displayed in any suitable format, such as, for example, in a list, as a post-it message on a bulletin board, etc. Any details related to the development experience may also be displayed, including any details provided by the creator of the development experience.

In addition, the career development host 102 may optionally (again as indicated by the broken lines in FIG. 3) receive a search inquiry from a seeker at 310. The seeker may search for development experiences, through their computing device 200, based on one or more filtering criteria. For example, a seeker may search for development experiences offered at the seeker's workplace location, for development experiences that include specific skills to be developed, for development experiences within a particular business unit, for development experiences lasting for a specified period of time (e.g., less than two hours, more than four hours, etc.), for development experiences requiring more than one participant, etc. The search may include a keyword search, a category search (e.g., based on a business unit, a location (e.g., a specific physical location, a virtual location, etc.), a skill set, etc.), or other search. In response to receiving the search inquiry from the seeker, the career development host 102 may then provide to the seeker all development experiences from the offer database 104 matching the search inquiry.

After viewing available development experiences (e.g., at 308, at 310, etc.), the seeker can select one or more that are of interest. In so doing, the career development host 102 then receives (via the computing device 200) an experience acceptance reply (also referred to as an application) from the seeker, at 312. For example, if the seeker finds a development experience that the seeker would like to participate in (e.g., upon viewing available development experiences, following the search at 310, etc.), the seeker can submit the acceptance reply or application (which is then received at 312). The acceptance reply indicates that the seeker is interested in and/or would like to participate in the offered (and available) development experience.

In some aspects, as part of receiving the acceptance reply (or application) at 312 from the seeker, the development host 102 may initially receive data regarding the reply via email, via one or more interfaces presented to the seeker (e.g., through the computing devices 200, etc.), etc. Then, after receiving the initial data, the development host 102 may generate the acceptance reply (or application) based on the received data.

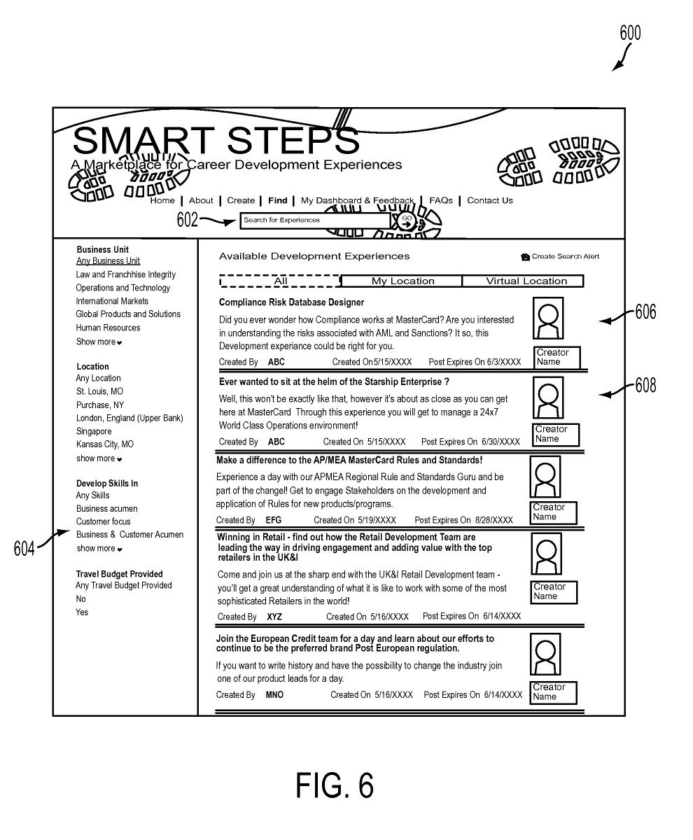

FIGS. 6-9 illustrate exemplary interfaces 600, 700, 800, 900 that may be displayed to the employee seeker, via the computing device 200, when searching for and applying for development experience opportunities. The interfaces 600, 700, 800, 900 may be available to the seeker through a unique homepage associated with the company and supported by the company intranet, through a unique page associated with the seeker, such as a seeker dashboard supported by the company intranet, etc. And again, the interfaces 600, 700, 800, 900 may be any graphical user interface (GUI) suitable for receiving information from an employee, such as, for example, an Internet webpage, a company employee portal, etc.

As shown in FIG. 6, the search can be performed using a search field 602 included in the interface 600. In this example, keywords are used to facilitate the search (e.g., where a search for the term “innovation” would return results for any experience with the word innovation in it), with default selections 604 and 606 then available to narrow the results as needed/desired (either before or after the keyword search). The interface also displays a listing 608 of all available development experience opportunities currently being offered. The listing may initially include all available development experience opportunities, and may then be modified to include a subset thereof following the search (where the subset then satisfies the search criteria). Each development experience in the listing 608 includes information related to the experience (e.g., a title of the experience, a creator employee associated with the experience, a brief description of the experience, important dates of the experience, etc.). Although FIG. 6 illustrates the multiple development experiences as displayed in a list format, it should be appreciated that other formats may be used to display the experiences, including but not limited to, bulletin board representation formats, post-it note representation formats, etc.

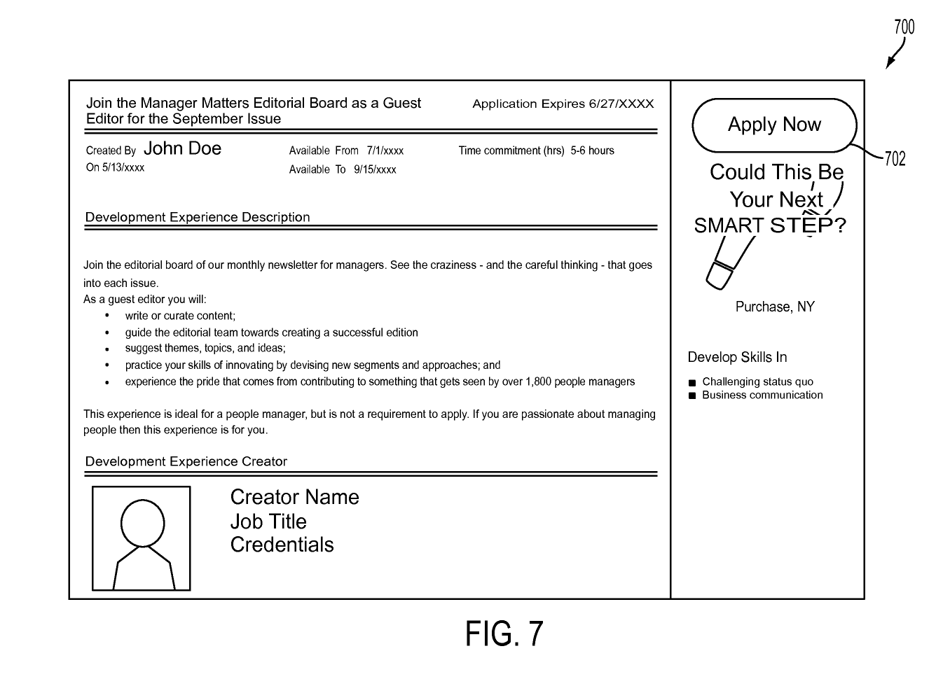

From the listing 608 of development experiences displayed in the interface 600 of FIG. 6, the seeker can then select an experience to view additional details (as shown in the interface 700 of FIG. 7). As shown in FIG. 7, the exemplary interface 700 displays the name of the employee creator, important dates of the development experience, a description of the development experience, and potential skills to be developed. A button 702 is then provided to allow the seeker to apply (e.g., provide the acceptance reply, provide the application, etc.) for the development experience if the seeker is interested.

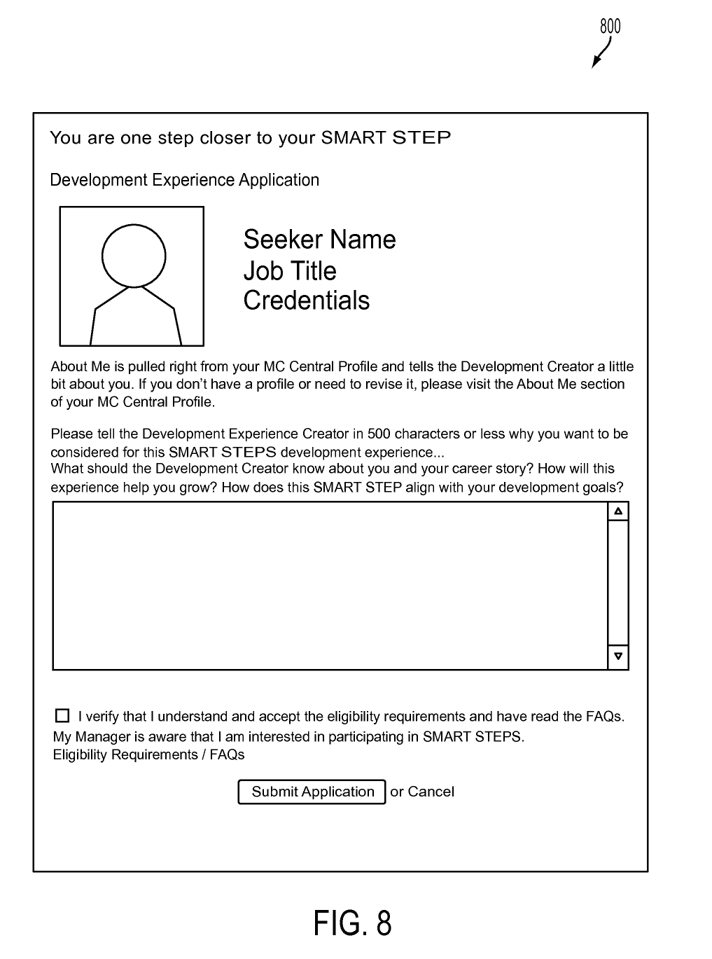

In some aspects, the acceptance reply/application from the seeker may also include a message from the seeker, which can be sent to the development experience creator. FIG. 8 illustrates an exemplary interface 800 that can be used by the seeker to provide such a message (e.g., after selecting the button 702 in the interface 700 of FIG. 7 to apply for the development experience, etc.). The message may include any information related to the seeker's potential participation in the development experience, such as, for example, seeker credentials, previous experience, motivation for desired participation in the experience, a personal message from the seeker, etc. The message gives the seeker an opportunity to explain why the seeker would be a good candidate to participate in the development experience. In some embodiments, the message may be limited in length (e.g., less than 150 words), in content (e.g., the seeker is not allowed to attach a resume, the seeker is only allowed to choose pre-created messages), etc., to save time for both the seeker and the creator in writing and reviewing the message, and create a less formal seeker selection process. And, in some embodiments, the company portal may recognize the seeker based on a profile stored on the company Intranet, and some fields of the acceptance reply and/or subsequent message (e.g., some fields in the interfaces 700, 800, etc.) may be automatically populated based on the stored employee information (e.g., employee name, job title, location, profile, etc.).

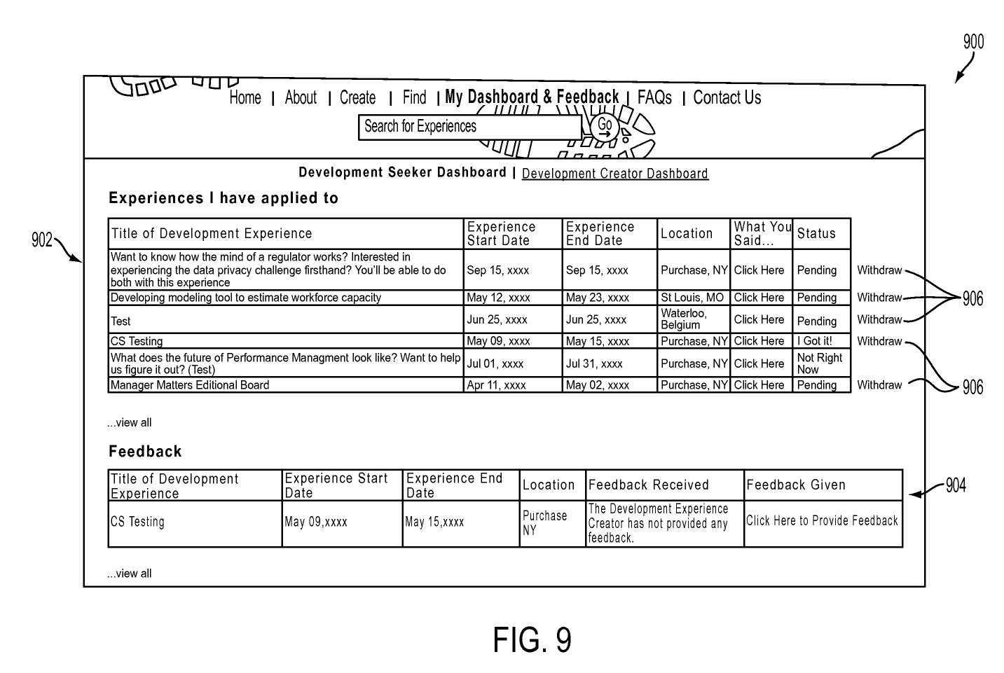

Once a seeker submits the acceptance reply/application for a development experience, through the interface 700, the development experience and/or application is posted to a seeker dashboard, an example of which is illustrated in the interface 900 of FIG. 9. The example seeker dashboard in FIG. 9 allows the employee seeker to view the experiences 902 for which the employee has applied, along with the rationales submitted to the development experience creator(s) for each experience and details of each experience (e.g., title, start date, end date, location, status (i.e., whether the seeker was selected or whether the creator has not yet made a decision), etc.). The illustrated seeker dashboard also allows the seeker to view feedback details 904 for completed development experiences. Further, the dashboard allows the seeker to withdraw an application for an experience via buttons 906. In some embodiments, the seeker may be required to provide a reason for withdrawing if the creator has already selected the seeker for the development experience.

Referring back to the method 300 illustrated in FIG. 3, in response to receiving the experience acceptance reply from the seeker at 312 (or after generating the reply based on the received data), the career development host 102 notifies (via the computing device 200) the creator associated with the development experience of the seeker's acceptance reply, at 314. The notification may include, for example, an email to the creator, a message in the creator's employee portal, etc. This notification lets the creator know that a seeker would like to participate in the development experience offered by the creator. The notification may be sent immediately once the seeker submits the acceptance reply, or the notification may be sent on a scheduled periodic basis. If multiple seekers submit acceptance replies for an offered development experience, the notification to the creator may include a list of all seekers wishing to participate, along with any messages from the seekers. In addition to sending a notification to the creator, the career development host 102 and/or offer database 104 may store any received acceptance replies for each offered development experience. In some embodiments, the creator may also be able to access the creator dashboard (e.g., the dashboard illustrated in the interface 400 in FIG. 4), and view which seeker employees have applied for the creator's development experience. Here, the creator may be able to view rationales provided by the seekers in their applications, and select the seeker(s) to participate in the experience directly from the creator's dashboard.

The career development host 102 next receives a reply selection from the creator, at 316. After being notified, and reviewing the seekers (and optionally their messages) requesting to participate in an offered development experience, the creator of the experience selects one or more of the seekers (depending on the number of allowed participants) that the creator determines would be the best fit for the development experience. In addition to receiving messages from each seeker, the creator may also be able to view the number of development experiences each seeker has participated in so far. Using all of the available information, the creator can determine which seeker(s) would be best suited to participate in the experience, and submit the selection(s) to the career development host 102 at 316. The career development host 102 may optionally store the reply selections in the offer database 104.

Again, in some aspects, as part of receiving the reply selection from the creator at 302, the development host 102 may initially receive data regarding the reply selection via email, via one or more interfaces presented to the creator (e.g., through the computing devices 200, etc.), etc. Then, after receiving the initial data, the development host 102 may generate the reply selection based on the received data.

In response to receiving the reply selection from the creator at 316 (or after generating the reply selection based on the received data), the career development host 102 notifies (via the computing device 200) the chosen seeker(s) of the reply selection at 318. The notification may include, for example, an email to the seeker, a message in the seeker's employee portal, etc. The notification lets the seeker know that the seeker has been selected by the creator to participate in the offered development experience. The notification may be sent as soon as the creator makes a reply selection, or may be sent on a scheduled periodic basis. Those seekers not chosen may be notified that they were not selected for that particular experience. If multiple seekers have been selected, the notification may be sent to all selected seekers at the same time. In some embodiments, the seekers may be informed which other seekers were selected. The notification may include a message from the creator, further instructions for participation in the development experience, etc., or the creator and seeker may discuss further information regarding the development experience separately. Seekers may be able to access their seeker dashboard (e.g., the dashboard illustrated in the interface 900 in FIG. 9), and view which experiences they have been selected for.

In some aspects, after a development experience is completed, automated notifications may be sent to the seeker and/or creator asking them to provide feedback on the experience. The feedback may be in the form of a brief survey, and may be accessed through the seeker and/or creator dashboards.

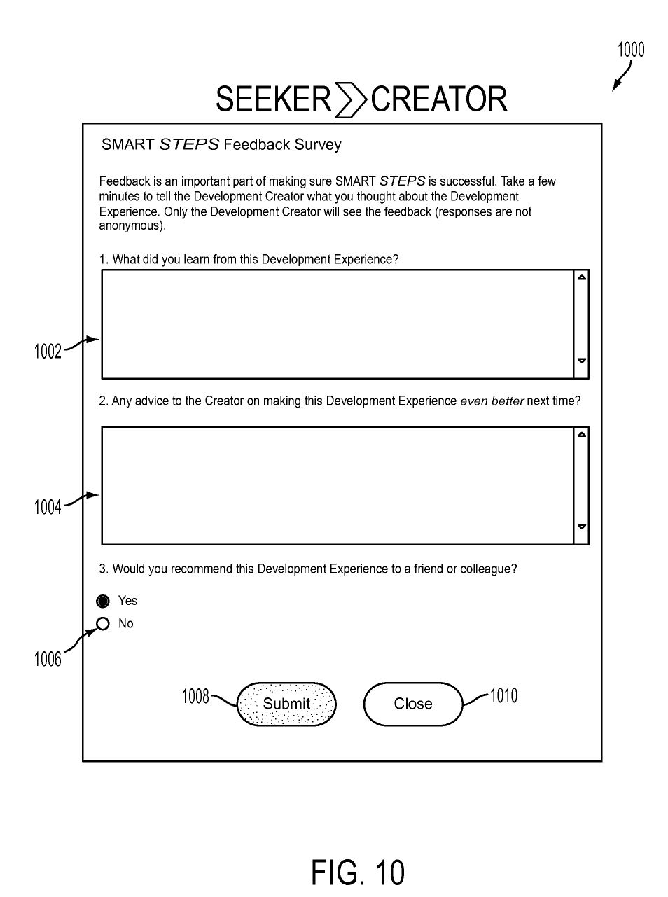

FIG. 10 illustrates an example interface 1000 that can be used for a seeker to provide feedback for a development experience. The illustrated interface 1000 includes text entry boxes 1002, 1004 and radio buttons 1006 to allow the seeker to provide information about what was learned during the experience, suggestions for improvement of the development experience, and whether or not the seeker would recommend the development experience to others. When complete, the seeker can use buttons 1008, 1010 to submit or close the interface. In some embodiments, the seeker's feedback may be provided to the creator of the experience.

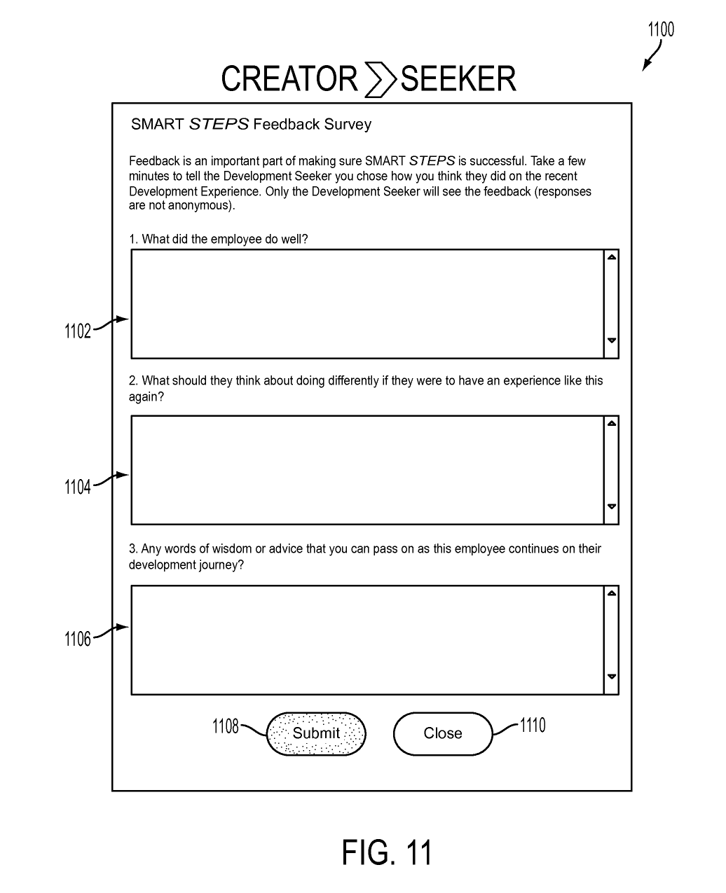

FIG. 11 illustrates an example interface 1100 that can be used for a creator to provide feedback for a development experience. The illustrated interface 1100 includes text entry boxes 1102-1106 to allow the creator to provide performance characteristics of the seeker during the experience, suggestions for improvement by the seeker, and advice for the seeker for further development. When complete, the creator can use buttons 1108, 1110 to submit or close the interface. In some embodiments, the creator's feedback may be provided to the seeker of the experience. And in some embodiments, the creator may be rewarded for creating the development experience (e.g., via a badging system, etc.).

As an alternative to, or in addition to, a creator requesting a new development experience offer, a seeker may originate and submit an experience wanted request. The experience wanted request may be indicative of a request from the seeker for a creator to create a specific type of development experience. The experience wanted request may be received by the career development host 102, and in response, the career development host 102 may generate an experience wanted posting in the offer database 104. The experience wanted posting may be similar to a “wanted ad” seeking a particular experience not currently available at the career development host 102.

Here, a seeker may wish to participate in a specific type of development experience that is not currently being offered by any creators. The seeker may submit the experience wanted request detailing what kind of development experience they would like to participate in. A creator can view the experience wanted requests, and if the creator is interested in offering a similar development experience, submit their own experience creation request to the career development host 102. Alternatively, a creator may reply directly to a seeker's experience wanted request to facilitate the development experience between the seeker and the creator. In some embodiments, the seeker may email a predetermined mailbox set-up for the company portal, and an administrator may coordinate the creation of a new development experience offer.

As an example, a software engineer may be interested in working on a presentation for a client, but there might not be any development experiences currently available offering work on a presentation for a client. The software engineer may then submit an experience wanted request for a client presentation development experience, possibly by emailing the predetermined mailbox set up by the career development host 102. An administrator viewing the experience wanted request may then work to get a client presentation experience offer created. And, a creator may then submit an experience creation request for developing a client presentation, to which the software engineer could submit an acceptance reply.

The embodiments herein thus permit employees to create and seek development experience opportunities. This may provide improved employee career development within the company, increase mentoring effectiveness for managers, and provide a self-service mechanism for employees to control their own career development, without requiring additional overhead and oversight of career development staff within the company. The embodiments herein give employees better visibility across different working groups, and more opportunities to develop new skill sets.

Again, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving multiple experience creation requests from multiple creators employed with the company, each experience creation request relating to an offer of a development experience to at least one other employee of the company, the development experience including at least one task outside a plurality of job duties of the at least one other employee; (b) compiling a database of the multiple development experiences based on the multiple experience creation requests, the database accessible to multiple seekers employed with the company; (c) receiving experience acceptance replies from the seekers for the development experiences in the database; and (d) notifying the creators of the development experiences of the experience acceptance replies from the seekers for said development experiences.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for managing career development experiences within a company, the system comprising:
a memory configured to store, in an offer database, development experience information for multiple career development experiences; and
a processor coupled to the memory, the processor configured to:
generate a development experience, in response to an experience creation request from a first employee of the company directed to a second employee of the company, the development experience including at least one task outside a plurality of job duties of the second employee;
post the development experience to the offer database; and
notify the first employee of an experience acceptance reply from the second employee, when the second employee indicates interest in participating in the development experience.

2. The system of claim 1, wherein the processor is further configured to:
generate a reply selection, in response to the second employee being chosen by the first employee to participate in the development experience; and
notify the second employee of the selection by the first employee.

3. The system of claim 1, wherein the processor is further configured to cause the development experience, posted to the offer database, to be displayed at a display device.

4. The system of claim 3, wherein the processor is further configured to:
search for particular development experiences in the offer database, in response to a search inquiry from the second employee; and
cause the particular development experiences to be displayed at the display device.

5. The system of claim 1, wherein each of the development experiences in the offer database has a total time period of less than or equal to about one day.

6. The system of claim 1, wherein each of the development experiences in the offer database has a total time period of less than or equal to about ten hours.

7. The system of claim 1, wherein the offer database is accessible to employees of the company through an internal network of the company.

8. The system of claim 1, wherein each of the development experiences in the offer database does not include a new job posting or new assignment posting.

9. The system of claim 1, wherein the processor is further configured to generate an experience wanted posting, indicative of a request from the second employee for a specific type of development experience.

10. The system of claim 1, wherein the experience acceptance reply includes a message from the second employee, the message including credentials and/or motivation information related to potential participation of the second employee in the development experience.

11. The system of claim 1, wherein each of the development experiences in the offer database includes one or more of a subject, a location, a time commitment, a length of the development experience, a skill to be developed, a description of the development experience, a number of employees needed to fill the development experience, a date of availability, and a date of expiration.

12. A computer implemented method of managing career development within a company having multiple employees, the method comprising:
receiving, at a computing device, multiple experience creation requests from multiple creators employed with the company, each experience creation request relating to an offer of a development experience to at least one other employee of the company, the development experience including at least one task outside a plurality of job duties of the at least one other employee;
compiling a database of the multiple development experiences, using the computing device, based on the multiple experience creation requests, the database accessible to multiple seekers employed with the company;
receiving, at the computing device, experience acceptance replies from the seekers for the development experiences in the database; and
notifying the creators of the development experiences of the experience acceptance replies from the seekers for said development experiences.

13. The method of claim 12, further comprising receiving, at the computing device, a reply selection from at least one of the creators indicating one or more seekers to participate in the development experience associated with the at least one of the creators.

14. The method of claim 12, further comprising receiving, at the computing device, search inquiries from the seekers relating to the development experiences in the database.

15. The method of claim 12, further comprising:
receiving, at the computing device, multiple development experience wanted requests from the seekers; and
compiling, at the computing device, a database of the development experience wanted requests.

16. A non-transitory computer readable media comprising computer-executable instructions that, when executed by at least one processor, cause the at least one processor to:
generate development experiences, based on requests from creators employed with a company, relating to offers of career development directed to at least one other employee of the company, wherein the development experiences do not include new jobs or new assignment postings;
post the development experiences to an offering list accessible to seekers employed with the company;
cause an interface to display and, via the interface, receive input from the seekers relating to experience acceptance replies for the development experiences on the offering list; and
for each development experience on the offering list, maintain a reply list of seekers, based on the received experience acceptance replies for said development experience.

17. The non-transitory computer readable media of claim 16, wherein the computer-executable instructions further cause the at least one processor to cause an interface to display and, via the interface, receive input from the creators, for each of the development experiences, relating to one or more reply selections of said development experience, the one or more reply selections indicating one or more seekers on the reply list to participate in the development experience.

18. The non-transitory computer readable media of claim 16, wherein the computer-executable instructions further cause the at least one processor to cause an interface to display and, via the interface, receive input from the seekers relating to search inquiries of the development experiences on the offering list, to which the seekers may reply for potential participation.

19. The non-transitory computer readable media of claim 16, wherein the computer-executable instructions further cause the at least one processor to:
generate development experience wanted postings, based on requests from the seekers; and
maintain a list of the development experience wanted postings.

20. The non-transitory computer readable media of claim 16, wherein each of the development experiences includes at least two of a subject, a location, a time commitment, a length of the development experience, a skill to be developed, a description of the development experience, a number of seekers needed to fill the development experience, a date of availability, and a date of expiration.
